(19) United States
(12) Patent Application Publication
(10) Pub. No.: US 2025/0026216 A1
(43) Pub. Date: Jan. 23, 2025

(54) ON-BOARD CHARGING SYSTEM FOR AN ELECTRIC VEHICLE

(71) Applicant: GM GLOBAL TECHNOLOGY OPERATIONS LLC, DETROIT, MI (US)

(72) Inventors: Minh-Khai Nguyen, Troy, MI (US); Lei Hao, Troy, MI (US); Chandra S. Namuduri, Troy, MI (US); Sanjeev M. Naik, Troy, MI (US)

(21) Appl. No.: 18/354,741

(22) Filed: Jul. 19, 2023

(51) Int. Cl. B60L 53/24; B60L 50/51; B60L 50/60; B60L 53/16; H02J 7/00; H02M 3/335; H02M 7/797; H02P 27/06

(52) U.S. Cl. CPC B60L 53/24; B60L 50/51; B60L 50/60; B60L 53/16; H02J 7/007; H02M 3/33573; H02M 3/33584; H02M 7/797; H02P 27/06; B60L 2210/10; B60L 2210/30; B60L 2210/40; B60L 2220/42; H02J 2207/20

(57) ABSTRACT

Embodiments include an electric vehicle having a charging port configured to receive an alternating current (AC) power, a direct current (DC) battery, and a bidirectional inverter configured to convert AC power to DC power and to convert DC power to AC power, the bidirectional inverter is selectively connected to the DC battery by propulsion switches. The electric vehicle also includes an AC motor connected to the bidirectional inverter and selectively connected to the charging port by a first charging switch, an isolated DC/DC converter motor selectively connected to the DC battery via a second charging switch and a third charging switch, and a processor configured to control the operation of the propulsion switches, the first charging switch, the second charging switch, and the third charging switch based on an operational mode of the electric vehicle.

### INTRODUCTION

The subject disclosure relates to electric vehicles. In particular, the invention relates to on-board charging systems for use in charging an electric vehicle.

An on-board charging module, also known as an on-board charger (OBC), is a component in an electric vehicle that is responsible for converting alternating current (AC) from an external power source, such as a charging station or wall outlet, into direct current (DC) for charging the vehicle's battery pack.

The on-board charging module is typically located within the EV and is connected to the charging port. When the vehicle is plugged into a power source, the OBC receives the AC power and uses internal circuitry to convert it into the appropriate DC voltage and current levels required by the vehicle's battery pack. This conversion process involves using a controllable rectifier to convert the AC power to DC and regulating the voltage and current to ensure safe and efficient charging.

The on-board charging module often incorporates various safety features and monitoring systems to protect against overcharging, overcurrent, and other potential issues. It may also communicate with the external charging station or power source to negotiate charging parameters and monitor charging progress.

### SUMMARY

In one exemplary embodiment an electric vehicle is provided. The electric vehicle includes a charging port configured to receive an alternating current (AC) power, a direct current (DC) battery, and a bidirectional inverter configured to convert AC power to DC power and to convert DC power to AC power, the bidirectional inverter is selectively connected to the DC battery by propulsion switches. The electric vehicle also includes an AC motor connected to the bidirectional inverter and selectively connected to the charging port by a first charging switch, an isolated DC/DC converter motor selectively connected to the DC battery via a second charging switch and a third charging switch, and a processor configured to control operation of the propulsion switches, the first charging switch, the second charging switch, and the third charging switch based on an operational mode of the electric vehicle.

In addition to one or more of the features described herein, the processor causes the propulsion switches to be in an open position and the first charging switch, the second charging switch, and the third charging switch to be in a closed position during a charging state of the electric vehicle.

In addition to one or more of the features described herein, the processor causes the propulsion switches to be in a closed position and the first charging switch, the second charging switch, and the third charging switch to be in an open position during an active state of the electric vehicle.

In addition to one or more of the features described herein, the operational mode of the electric vehicle is determined based on detecting a connection of a charging source to the charging port.

In addition to one or more of the features described herein, the AC motor includes a neutral point connected to windings of the AC motor and wherein the neutral point of the AC motor is selectively connected to the charging port by the first charging switch.

In addition to one or more of the features described herein, the AC motor includes three sets of windings and wherein the AC motor is selectively connected, by the first charging switch, between one of three sets of windings and the bidirectional inverter.

In addition to one or more of the features described herein, the electric vehicle also includes a second AC motor connected to the bidirectional inverter and selectively connected to the charging port by a fourth charging switch.

In addition to one or more of the features described herein, the second AC motor includes a neutral point connected to windings of the second AC motor and wherein the neutral point of the second AC motor is selectively connected to the charging port by the fourth charging switch.

In addition to one or more of the features described herein, the AC motor includes three sets of windings and wherein connections between each of the three sets of windings of the AC motor and the bidirectional inverter are selectively connected to the charging port by the first charging switch, a fourth charging switch, and a fifth charging switch respectively and wherein a first charging switch connects the AC motor to the bidirectional inverter.

In addition to one or more of the features described herein, the processor is configured to control operation of the first charging switch, the fourth charging switch, and the fifth charging switch to ensure that only one of the first charging switch, the fourth charging switch, and the fifth charging switch are in a closed position at a time and wherein a determination on which of the first charging switch, the fourth charging switch, and the fifth charging switch to close is based at least in part on a temperature of the three sets of windings of the AC motor.

In one exemplary embodiment an on-board charging system for an electric vehicle is provided. The on-board charging system includes a charging port configured to receive an alternating current (AC) power, a direct current (DC) battery, and a bidirectional inverter configured to convert AC power to DC power and to convert DC power to AC power, the bidirectional inverter is selectively connected to the DC battery by propulsion switches. The electric vehicle also includes an AC motor connected to the bidirectional inverter and selectively connected to the charging port by a first charging switch, an isolated DC/DC converter motor selectively connected to the DC battery via a second charging switch and a third charging switch, and a processor configured to control operation of the propulsion switches, the first charging switch, the second charging switch, and the third charging switch based on an operational mode of the electric vehicle.

In addition to one or more of the features described herein, the processor causes the propulsion switches to be in an open position and the first charging switch, the second charging switch, and the third charging switch to be in a closed position during a charging state of the electric vehicle.

In addition to one or more of the features described herein, the processor causes the propulsion switches to be in a closed position and the first charging switch, the second charging switch, and the third charging switch to be in an open position during an active state of the electric vehicle.

In addition to one or more of the features described herein, the operational mode of the electric vehicle is determined based on detecting a connection of a charging source to the charging port.

In addition to one or more of the features described herein, the AC motor includes a neutral point connected to windings of the AC motor and wherein the neutral point of the AC motor is selectively connected to the charging port by the first charging switch.

In addition to one or more of the features described herein, the AC motor includes three sets of windings and wherein the AC motor is selectively connected, by the first charging switch, between one of three sets of windings and the bidirectional inverter.

In addition to one or more of the features described herein, the on-board charging system also includes a second AC motor connected to the bidirectional inverter and selectively connected to the charging port by a fourth charging switch.

In addition to one or more of the features described herein, the second AC motor includes a neutral point connected to windings of the second AC motor and wherein the neutral point of the second AC motor is selectively connected to the charging port by the fourth charging switch.

In addition to one or more of the features described herein, the AC motor includes three sets of windings and wherein connections between each of the three sets of windings of the AC motor and the bidirectional inverter are selectively connected to the charging port by the first charging switch, a fourth charging switch, and a fifth charging switch respectively and wherein a first charging switch connects the AC motor to the bidirectional inverter.

In addition to one or more of the features described herein, the processor is configured to control operation of the first charging switch, the fourth charging switch, and the fifth charging switch to ensure that only one of the first charging switch, the fourth charging switch, and the fifth charging switch are in a closed position at a time and wherein a determination on which of the first charging switch, the fourth charging switch, and the fifth charging switch to close is based at least in part on a temperature of the three sets of windings of the AC motor.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic diagram of a vehicle for use in conjunction with one or more embodiments of the present disclosure;

FIG. 2 is a block diagram of an on-board charging system of an electric vehicle for use in conjunction with one or more embodiments of the present disclosure;

FIG. 3A is a circuit diagram of an on-board charging system of an electric vehicle in accordance with one or more embodiments of the present disclosure;

FIG. 3B is a circuit diagram of an on-board charging system of an electric vehicle in accordance with one or more embodiments of the present disclosure;

FIG. 3C is a circuit diagram of an on-board charging system of an electric vehicle in accordance with one or more embodiments of the present disclosure;

FIG. 3D is a circuit diagram of an on-board charging system of an electric vehicle in accordance with one or more embodiments of the present disclosure; and

FIG. 3E is a circuit diagram of an on-board charging system of an electric vehicle in accordance with one or more embodiments of the present disclosure.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, an electric vehicle having an improved onboard charging system is provided. In exemplary embodiments, the on-board charging system of the electric vehicle includes an alternating current (AC) motor that acts as an inductor, and a bidirectional inverter connected to the AC motor that acts as a synchronous rectifier. As a result, when a single-phase or three phase AC power is applied to the AC motor, the bidirectional inverter will produce a direct current (DC) power. This DC power is provided to an isolated DC/DC converter, which produces a DC output that charges the battery of the electric vehicle. As a result, the AC motor and the bidirectional inverter are used to charge the DC battery of the electric vehicle in addition to being used to provide propulsion for the electric vehicle. Advantageously, by utilizing the existing AC motor and bidirectional inverter of an electric vehicle to convert AC power to DC power for charging the electric vehicle, the controllable rectifier found in existing on-board chargers of electric vehicles can be removed, thereby reducing the complexity and cost of the on-board charging system.

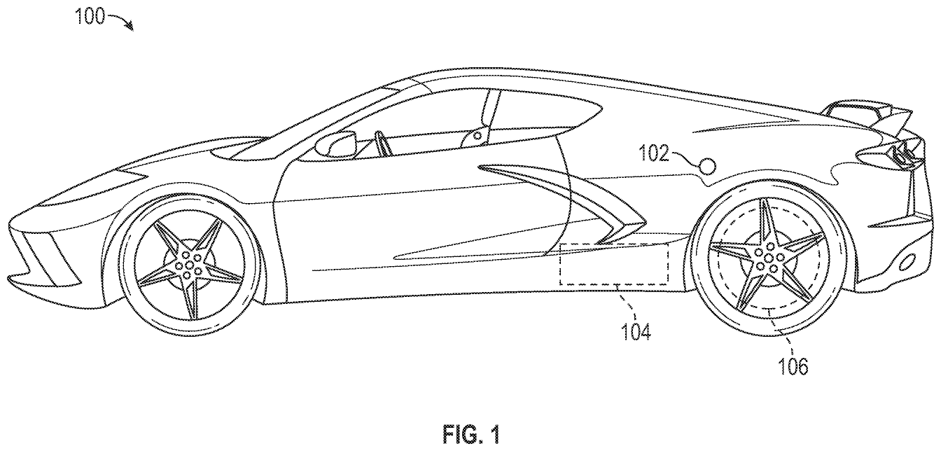

Referring now to FIG. 1, a schematic diagram of a vehicle 100 for use in conjunction with one or more embodiments of the present disclosure is shown. The vehicle 100 includes a charging port 102, a battery 104, and an electric motor 106. In one embodiment, the vehicle 100 is a hybrid vehicle that utilizes both an internal combustion engine and an electric motor. In another embodiment, the vehicle 100 is an electric vehicle that only utilizes electric motors. In exemplary embodiments, the vehicle 100 is configured to be connected, via charging port 102, to a single-phase or three phase AC power source, which is used to charge the battery 104. In the following description, the single-phase AC is used as an example, the concept may also be applied to three phase AC power source. The electric motor 106 is configured to receive power from the battery 104 to provide propulsion for the vehicle 100. In exemplary embodiments, the battery 104 is configured to supply direct-current (DC) power to an inverter (not shown), which converts the DC power into three-phase alternating-current (AC) power. The three-phase AC power is supplied to the electric motor 106 to propulsion for the vehicle 100.

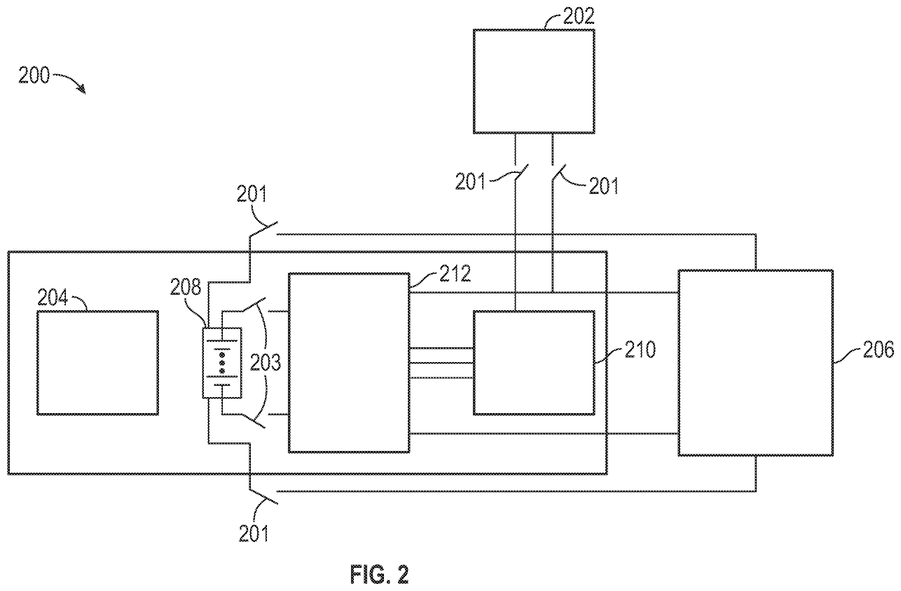

Referring now to FIG. 2, a schematic diagram of an on-board charging system 200 of an electric vehicle for use in conjunction with one or more embodiments of the present disclosure is shown. As illustrated, the on-board charging system 200 includes a charging port 202, a processor 204, an isolated DC/DC converter 206, a DC battery 208, an AC motor 210, a bidirectional inverter 212, a plurality of charging switches 201 and a plurality of propulsion switches 203.

The charging port 202 is configured to receive a single-phase AC power from a charging source. In one embodiment, the single-phase AC power has a voltage of between eighty-five and two-hundred and seventy volts. In one embodiment, the charging port 202 includes one or more sensors (not shown) that are configured to detect that a charging source has been connected to the charging port 200. In one embodiment, the sensors are in communication with the processor 204.

The direct current (DC) battery 208 is a high-voltage battery and has a capacity of greater than approximately three hundred volts. In one embodiment, the battery 208 is a Lithium-ion battery. The battery 208 can include one or more NCM (Lithium Nickel Manganese Cobalt Oxide) battery cells and one or more LFP (Lithium Iron Phosphate) battery cells.

The bidirectional inverter 212 is configured to convert AC power to DC power and to convert DC power to AC power, the bidirectional inverter is selectively connected to the DC battery by propulsion switches 203. The term “bidirectional” indicates that the inverter can operate in both directions, allowing power to flow in and out of the battery 208.

In the AC-to-DC mode, or rectification mode, the bidirectional inverter 212 converts AC power from the motor 210 into DC power. The AC input from the motor 218 is connected to the bidirectional inverter 212, which is connected to the isolated DC/DC converter 206. The isolated DC/DC converter 206 is connected to the battery 208 by charging switches 201. A rectifier of the bidirectional inverter 212 converts the AC input into DC using power electronic switches (such as insulated-gate bipolar transistors or IGBTs).

In DC-to-AC mode, or inversion mode, the bidirectional inverter 212 converts DC power from the battery 208 into AC power. The DC output from the battery 208 is connected to the bidirectional inverter 212 via propulsion switches 203. The inverter of the bidirectional inverter 212 converts the DC input into AC using power electronic switches (such as insulated-gate bipolar transistors, IGBTs, wide bandgap switches, or the like). For example, the bidirectional inverter 212 can use pulse-width modulation (PWM) techniques to convert the DC power into a high-frequency AC waveform. In exemplary embodiments, the bidirectional inverter 212 includes a control circuit that regulates the AC output voltage and frequency to match the requirements of the motor 210.

The on-board charging system 200 utilizes one or more AC motors 210 of the electric vehicle, which are also used to provide propulsion to the electric vehicle, to charge the battery 208. In one embodiment, the AC motor 210 is selectively connected to the charging port 202 by a first charging switch 201. During a charging mode of the electric vehicle, the processor 204 closes the first charging switch 201 allowing AC power to flow from the charging port 202 to the electric motor. In one embodiment, the AC power can be provided to one of the windings of the AC motor 210 or to a neutral point of the windings of the AC motor 210. The motor winding act as an inductor for the provided AC power.

The on-board charging system 200 includes an isolated DC/DC converter 206 that is selectively connected to the DC battery via a second charging switch 201 and a third charging switch 201. During a charging mode of the electric vehicle, the processor 204 closes the second and third charging switch 201 and opens switch 203 allowing DC power to flow from the isolated DC/DC converter 206 to the battery 208. The isolated DC/DC converter 206 is configured to convert the DC power output of the bidirectional inverter 212 into the DC output voltage suitable for charging the battery 208. In addition, the isolated DC/DC converter 206 provides electrical isolation between AC power source (no shown) and the battery 208.

The processor 204 controls the operation of the propulsion switches 203 and the charging switches 201 of the on-board charging system 200. During a propulsion mode of the electric vehicle, the processor 204 closes the propulsion switches 203 allowing DC power to flow from the battery 208 through the bidirectional inverter 212, which provides AC power to the motor 210. During the propulsion mode of the electric vehicle, the processor 204 opens all of the charging switches 201. During the charging mode of the electric vehicle, the processor 204 closes the charging switches 201 allowing AC power to flow from the charging port 202 through the motor 210 to bidirectional inverter 212, which provides DC power to the isolated DC/DC converter 206. The DC/DC converter 206 then provides DC power to the battery 208. During the charging mode of the electric vehicle, the processor 204 opens all of the propulsion switches 203.

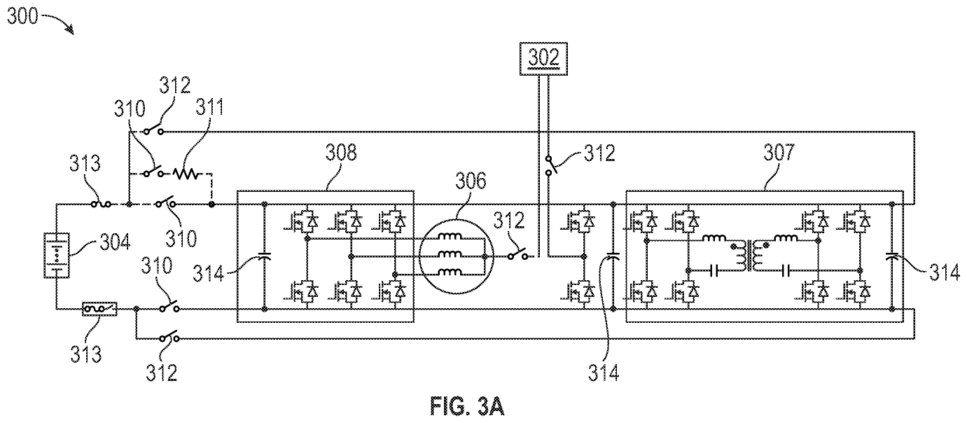

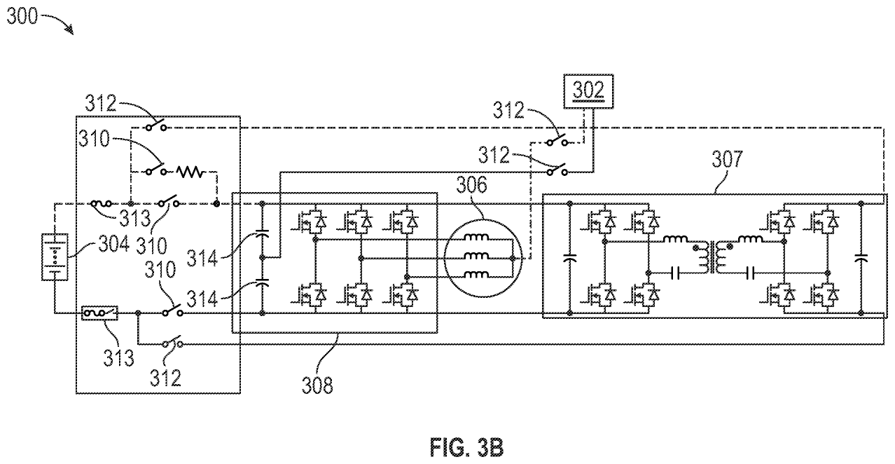

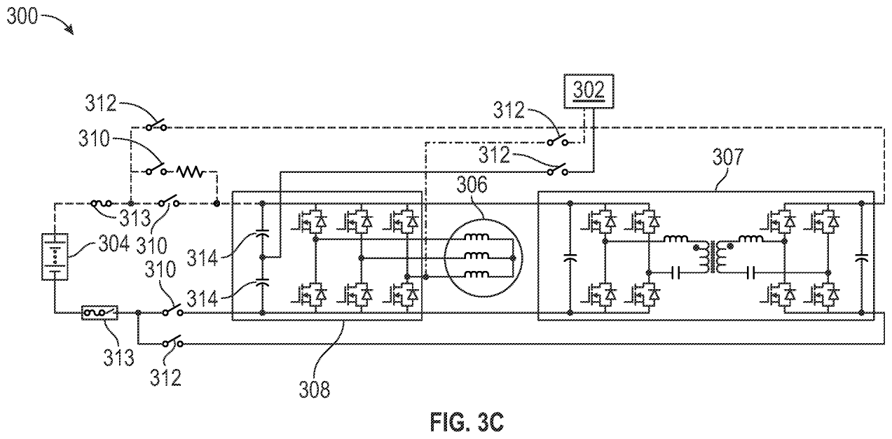

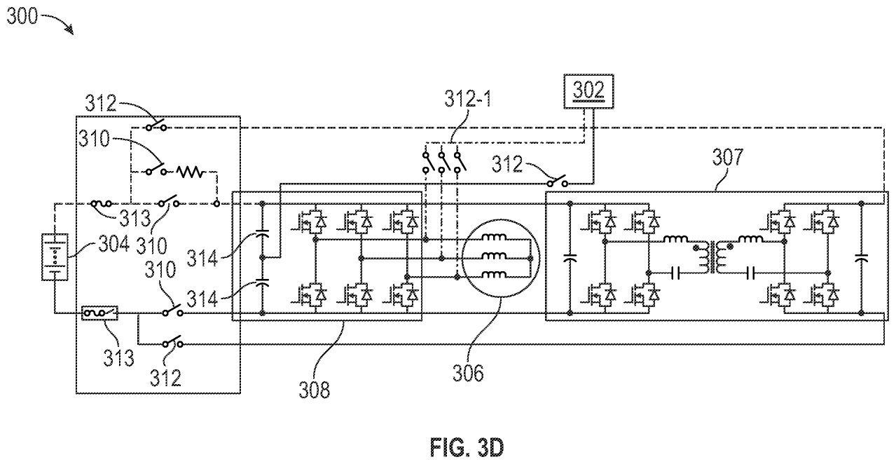

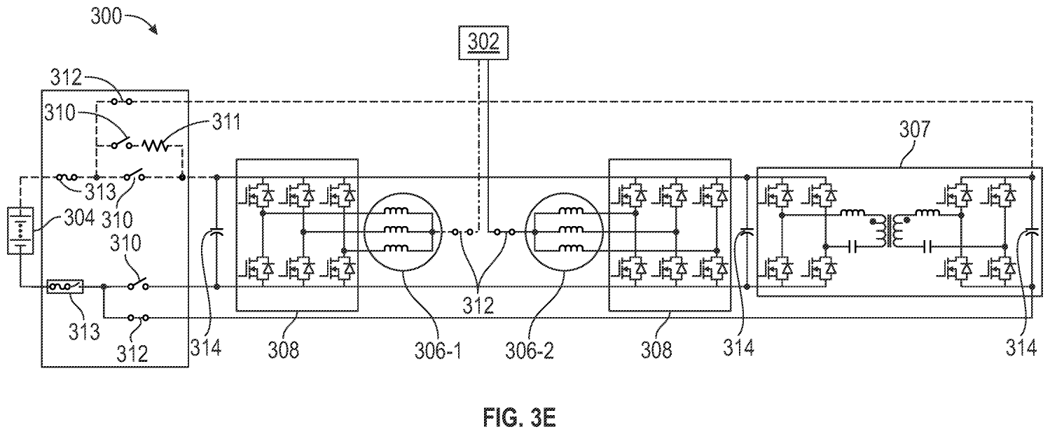

FIGS. 3A, 3B, 3C, 3D, and 3E each illustrate circuit diagrams of example configurations of an on-board charging system 300 in accordance with one or more embodiments of the present disclosure. The on-board charging system 300 includes a charging port 302, a DC battery 304, an AC Motor 306, an isolated DC/DC converter 307, a bidirectional inverter 308, propulsion switches 310, a pre-charge resistor 311, charging switches 312, fuses 313, and capacitors 314.

In one embodiment, as shown in FIG. 3A, a positive terminal of the charging port 302 of on-board charging system 300 is selectively connected to a neutral point of the windings of the AC motor 306 via a charging switch 312. The negative terminal of the charging port 302 of on-board charging system 300 is selectively connected to IGBTs, which are connected in parallel to the bidirectional inverter 308 and the isolated DC/DC converter 307. In this configuration, the windings of the AC motor 306 act as an inductor and the bidirectional inverter 308 acts as a synchronous rectifier.

In one embodiment, as shown in FIG. 3B, a positive terminal of the charging port 302 of on-board charging system 300 is selectively connected to a neutral point of the windings of the AC motor 306 via a charging switch 312. In this configuration, the capacitor of the bidirectional inverter 308 is split into two capacitors 314 and the negative of the charging port 302 of on-board charging system 300 is selectively connected between two the capacitors 314 of the bidirectional inverter 308. In this configuration, the windings of the AC motor 306 act as an inductor and the bidirectional inverter 308 acts as a synchronous rectifier.

In one embodiment, as shown in FIG. 3C, a positive terminal of the charging port 302 of on-board charging system 300 is selectively connected, via a charging switch 312, between one of the windings of the AC motor 306 and the bidirectional inverter 308. In this configuration, the capacitor of the bidirectional inverter 308 is split into two capacitors 314 and the negative of the charging port 302 of on-board charging system 300 is selectively connected between two the capacitors 314 of the bidirectional inverter 308. In this configuration, the windings of the AC motor 306 act as an inductor and the bidirectional inverter 308 acts as a synchronous rectifier.

In some cases, the configuration shown in FIG. 3C may cause the winding of the AC motor 306 that is connected to the positive terminal of the charging port 302 to become hot, which can negatively impact the charging performance and/or the performance of the AC motor 306. Accordingly, in another embodiment, as shown in FIG. 3D, a positive terminal of the charging port 302 of on-board charging system 300 is selectively connected, via three charging switches 312-1, between the windings of the AC motor 306 and the bidirectional inverter 308. In this configuration, the three charging switches 312-1 are actively controlled by a processor (not shown) such that only one of the three charging switches 312-1 is closed at any time. The processor is configured to monitor the temperature of the windings of the AC motor 306 and to selectively control the three charging switches 312-1 to prevent any of the windings of the AC motor 306 from exceeding a threshold temperature. In this configuration, the capacitor of the bidirectional inverter 308 is split into two capacitors 314 and the negative of the charging port 302 of on-board charging system 300 is selectively connected between two the capacitors 314 of the bidirectional inverter 308. In this configuration, the windings of the AC motor 306 act as an inductor and the bidirectional inverter 308 acts as a synchronous rectifier.

In one embodiment, as shown in FIG. 3E, a positive terminal of the charging port 302 of on-board charging system 300 is selectively connected to a neutral point of the windings of a first AC motor 306-1 via a charging switch 312. The negative terminal of the charging port 302 of on-board charging system 300 is selectively connected to a neutral point of the windings of a second AC motor 306-2 via a charging switch 312. In this configuration, the windings of the AC motors 306-1, 306-2 both act as inductors and the bidirectional inverter 308 acts as a synchronous rectifier.

In exemplary embodiments, fuses 313 are disposed adjacent to the terminals of the DC battery 304 and are configured to prevent damage to the DC battery by preventing current flow in excess of a threshold level into or out of the DC battery 304. In one embodiment, a pre-charge resistor 311 is disposed between one of the propulsion switches 310 and the bidirectional inverter 308. The pre-charge resistor 311 is configured to slowly charge the capacitors 314 of the bidirectional inverter 308 before the bidirectional inverter 308 is powered up and to prevent a large amount of inrush current into the bidirectional inverter 308.

In exemplary embodiments, when the charging port 302 is connected between one of the set of windings of the AC motor and the bidirectional inverter, the phase current and angle of the current flowing through the AC motor 306 is controlled by the bidirectional inverter 308 to prevent relative movement between a rotor and a stator of the AC motor 306.

The various configurations of on-board charging systems 300 shown in FIGS. 3A, 3B, 3C, 3D, and 3E are provided as examples of on-board charging systems and are not intended to be limiting. Those of ordinary skill in the art will appreciate that other configurations of the on-board charging systems 300 in accordance with this disclosure are possible.

In exemplary embodiments, when the on-board charging system 300 is in a charging mode (e.g., when the charging switches are ON and the propulsion switches are OFF), the on-board charging system 300 can be configured to receive power from the charging port 302 and charge the DC battery 304 or to provide AC power to the charging port 302 from the DC battery 304. As a result, the DC battery 304 of the electric vehicle can be used to provide power to devices outside of the electric vehicle.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An electric vehicle comprising:
a charging port configured to receive an alternating current (AC) power;
a direct current (DC) battery;
a bidirectional inverter configured to convert AC power to DC power and to convert DC power to AC power, the bidirectional inverter is selectively connected to the DC battery by propulsion switches;
an AC motor connected to the bidirectional inverter and selectively connected to the charging port by a first charging switch;
an isolated DC/DC converter motor selectively connected to the DC battery via a second charging switch and a third charging switch; and
a processor configured to control operation of the propulsion switches, the first charging switch, the second charging switch, and the third charging switch based on an operational mode of the electric vehicle.

2. The electric vehicle of claim 1, wherein during a charging state of the electric vehicle, the processor causes the propulsion switches to be in an open position and the first charging switch, the second charging switch, and the third charging switch to be in a closed position.

3. The electric vehicle of claim 1, wherein during an active state of the electric vehicle, the processor causes the propulsion switches to be in a closed position and the first charging switch, the second charging switch, and the third charging switch to be in an open position.

4. The electric vehicle of claim 1, wherein the operational mode of the electric vehicle is determined based on detecting a connection of a charging source to the charging port.

5. The electric vehicle of claim 1, wherein the AC motor includes a neutral point connected to windings of the AC motor and wherein the neutral point of the AC motor is selectively connected to the charging port by the first charging switch.

6. The electric vehicle of claim 1, wherein the AC motor includes three sets of windings and wherein the charging port is selectively connected, by the first charging switch, between one of three sets of windings and the bidirectional inverter.

7. The electric vehicle of claim 1, further comprising a second AC motor connected to the bidirectional inverter and selectively connected to the charging port by a fourth charging switch.

8. The electric vehicle of claim 7, wherein the second AC motor includes a neutral point connected to windings of the second AC motor and wherein the neutral point of the second AC motor is selectively connected to the charging port by the fourth charging switch.

9. The electric vehicle of claim 1, wherein the AC motor includes three sets of windings and wherein connections between each of the three sets of windings of the AC motor and the bidirectional inverter are selectively connected to the charging port by the first charging switch, a fourth charging switch, and a fifth charging switch respectively and wherein a first charging switch connects the AC motor to the bidirectional inverter.

10. The electric vehicle of claim 9, wherein the processor is configured to control operation of the first charging switch, the fourth charging switch, and the fifth charging switch to ensure that only one of the first charging switch, the fourth charging switch, and the fifth charging switch are in a closed position at a time and wherein a determination on which of the first charging switch, the fourth charging switch, and the fifth charging switch to close is based at least in part on a temperature of the three sets of windings of the AC motor.

11. An on-board charging system for an electric vehicle, the on-board charging system comprising:
a direct current (DC) battery;
a bidirectional inverter configured to convert AC power to DC power and to convert DC power to AC power, the bidirectional inverter is selectively connected to the DC battery by propulsion switches;
an AC motor connected to the bidirectional inverter and selectively connected to a charging port by a first charging switch, wherein the charging port receives AC power during a charging mode;
an isolated DC/DC converter motor selectively connected to the DC battery via a second charging switch and a third charging switch; and
a processor configured to control operation of the propulsion switches, the first charging switch, the second charging switch, and the third charging switch based on an operational mode of the electric vehicle.

12. The on-board charging system of claim 11, wherein during a charging state of the electric vehicle, the processor causes the propulsion switches to be in an open position and the first charging switch, the second charging switch, and the third charging switch to be in a closed position.

13. The on-board charging system of claim 11, wherein during an active state of the electric vehicle, the processor causes the propulsion switches to be in a closed position and the first charging switch, the second charging switch, and the third charging switch to be in an open position.

14. The on-board charging system of claim 11, wherein the AC motor includes a neutral point connected to windings of the AC motor and wherein the neutral point of the AC motor is selectively connected to the charging port by the first charging switch.

15. The on-board charging system of claim 11, wherein the AC motor includes three sets of windings and wherein the charging port is selectively connected, by the first charging switch, between one of three sets of windings and the bidirectional inverter.

16. The on-board charging system of claim 11, further comprising a second AC motor connected to the bidirectional inverter and selectively connected to the charging port by a fourth charging switch.

17. The on-board charging system of claim 16, wherein the second AC motor includes a neutral point connected to windings of the second AC motor and wherein the neutral point of the second AC motor is selectively connected to the charging port by the fourth charging switch.

18. The on-board charging system of claim 11, wherein the AC motor includes three sets of windings and wherein connections between each of the three sets of windings of the AC motor and the bidirectional inverter are selectively connected to the charging port by the first charging switch, a fourth charging switch, and a fifth charging switch respectively and wherein a first charging switch connects the AC motor to the bidirectional inverter.

19. The on-board charging system of claim 18, wherein the processor is configured to control operation of the first charging switch, the fourth charging switch, and the fifth charging switch to ensure that only one of the first charging switch, the fourth charging switch, and the fifth charging switch are in a closed position at a time and wherein a determination on which of the first charging switch, the fourth charging switch, and the fifth charging switch to close is based at least in part on a temperature of the three sets of windings of the AC motor.

20. An electric vehicle comprising:
a charging port configured to receive an alternating current (AC) power;
a direct current (DC) battery;
a bidirectional inverter configured to convert AC power to DC power and to convert DC power to AC power, the bidirectional inverter is selectively connected to the DC battery by propulsion switches;
an AC motor connected to the bidirectional inverter and selectively connected to the charging port by a first charging switch;
an isolated DC/DC converter motor selectively connected to the DC battery via a second charging switch and a third charging switch; and
a processor configured to control operation of the propulsion switches, the first charging switch, the second charging switch, and the third charging switch based on an operational mode of the electric vehicle,
wherein during an active state of the electric vehicle, the processor causes the propulsion switches to be in a closed position and the first charging switch, the second charging switch, and the third charging switch to be in an open position, and
wherein during a charging state of the electric vehicle, the processor causes the propulsion switches to be in an open position and the first charging switch, the second charging switch, and the third charging switch to be in a closed position.
